(19) United States
(12) Patent Application Publication
(10) Pub. No.: US 2015/0124623 A1
(43) Pub. Date: May 7, 2015

(54) System and Method for Traffic Splitting

(71) Applicant: Futurewei Technologies, Inc., Plano, TX (US)

(72) Inventors: Xu Li, Nepean (CA); Hamidreza Farmanbar, Ottawa (CA)

(21) Appl. No.: 14/536,064

(22) Filed: Nov. 7, 2014

Related U.S. Application Data
(60) Provisional application No. 61/901,071, filed on Nov. 7, 2013.

(51) Int. Cl. H04L 12/803; H04L 12/707; H04W 28/02; H04L 12/851

(52) U.S. Cl. CPC H04L 47/125; H04L 47/2441; H04L 45/24; H04W 28/0284
USPC 370/236; 370/235

(57) ABSTRACT

In one embodiment, a method for traffic splitting includes detecting congestion in a traffic flow and splitting the traffic flow into a first sub-flow and a second sub-flow after detecting congestion in the traffic flow. The method also includes transmitting, by a first node to a destination node, the first sub-flow along a first path and transmitting, by the first node to a second node, the second sub-flow along a second path, where the second sub-flow is destined for the destination node.

### CROSS-REFERENCE TO RELATED APPLICATIONS

This application claims the benefit of U.S. Provisional Application Ser. No. 61/901,071 filed on Nov. 7, 2013, and entitled “System and Method for Traffic Engineering by Local Traffic Splitting,” which application is hereby incorporated herein by reference.

### TECHNICAL FIELD

The present invention relates to a system and method for communications, and, in particular, to a system and method for traffic splitting.

### BACKGROUND

Imperfect knowledge may cause problems in traffic splitting in traffic engineering (TE). For examples, knowledge of channel and rate transients, spectral efficiency (SE), and delay may be imperfect. Also, modeling error may be introduced. Imperfect traffic splitting leads to the under-provisioning of some nodes and the over-provisioning of other nodes. Under-provisioning leads to congestion, which results in reduced quality of experience (QoE) or quality of service (QoS) for users. For example, there may be an increased packet loss, increased delay, increased delay jitter, and decreased data rate. Traffic engineering may not re-run to correct its decisions in real time due to operational factors, such as complexity and delay.

### SUMMARY

An embodiment method for traffic splitting includes detecting congestion in a traffic flow and splitting the traffic flow into a first sub-flow and a second sub-flow after detecting congestion in the traffic flow. The method also includes transmitting, by a first node to a destination node, the first sub-flow along a first path and transmitting, by the first node to a second node, the second sub-flow along a second path, where the second sub-flow is destined for the destination node.

An embodiment method for traffic splitting includes receiving, by a first communications controller from a second communications controller, an identity of a user equipment (UE) and determining a maximum rate the first communications controller can provide to the UE. The method also includes transmitting, by the first communications controller to the second communications controller, the maximum rate and receiving, by the first communications controller, a traffic flow having a first rate, where the rate is less than or equal to the maximum rate.

An embodiment communications node includes a processor and a non-transitory computer readable storage medium storing programming for execution by the processor. The programming includes instructions to detect congestion in a traffic flow and split the traffic flow into a first sub-flow and a second sub-flow when there is congestion in the traffic flow. The programming also includes instructions to transmit, to a destination node, the first sub-flow and transmit, to another communications node, the second sub-flow, where the second sub-flow is destined for the destination node.

The foregoing has outlined rather broadly the features of an embodiment of the present invention in order that the detailed description of the invention that follows may be better understood. Additional features and advantages of embodiments of the invention will be described hereinafter, which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates a diagram of a wireless network for communicating data;

FIG. 2 illustrates an embodiment wireless system for local traffic splitting;

FIG. 3 illustrates signaling in an embodiment wireless system for local traffic splitting;

FIG. 4 illustrates another embodiment wireless system for local traffic splitting;

FIG. 5 illustrates an embodiment wired system for local traffic spitting;

FIG. 6 illustrates another embodiment wired system for local traffic splitting;

FIG. 7 illustrates a flowchart for an embodiment method of local traffic splitting performed by a congested node;

FIG. 8 illustrates a flowchart for an embodiment method of local traffic splitting performed by a helper node;

FIG. 9 illustrates a flowchart for another embodiment method of local traffic splitting performed by a congested node;

FIG. 10 illustrates a flowchart for an embodiment method of local traffic splitting performed by a source node;

FIG. 11 illustrates a flowchart for an additional embodiment method of local traffic splitting performed by a congested node; and

FIG. 12 illustrates a block diagram of an embodiment computer system.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

In a data network, congestion may be handled in a variety of ways. In one example, traffic engineering is triggered based on buffer status. Another example uses radio coordination, for example coordinated multi-point (CoMP) or power control. In an additional example, dynamic alternate routing is used, which alternates between candidate routes each time a single route is used. Candidate routes may be pre-computed or dynamically discovered. Alternatively, adaptive flow splitting is performed, where routing paths are fixed, and traffic splitting is adjusted.

An embodiment resolves congestion locally during traffic engineering (TE) intervals without triggering traffic engineering. A local splitting technique is used, where nodes monitor their respective buffer status for individual flows. When, for a given flow, the buffer is above a threshold, the flow is split using neighboring nodes. The splitting may be done in accordance with the resource availability of neighboring nodes and their respective link qualities to the flow destination. The node may be located anywhere in a communications system. For example, the node may be a wireless communications controller in the wireline, or backhaul, network. Local splitting may include a mechanism of reacting to per-flow buffer overrun or congestion and/or signaling from other nodes. An embodiment provides a quick response with a low signaling overhead. In one embodiment, local splitting occurs at wireless communications controllers to resolve congestion on access links with communications between neighboring controllers. In another embodiment, any node(s) in a flow path may perform traffic splitting.

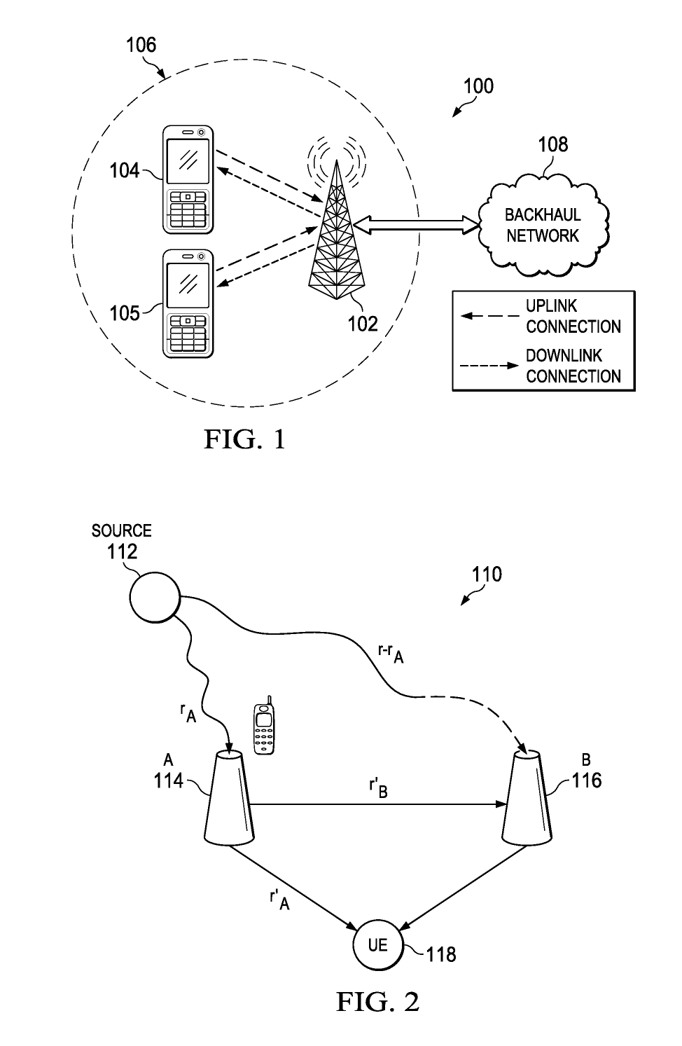

FIG. 1 illustrates network 100 for communicating data. Network 100 includes communications controller 102 having a coverage area 106, a plurality of user equipments (UEs), including UE 104 and UE 105, and backhaul network 108. Two UEs are depicted, but many more may be present. Communications controller 102 may be any component capable of providing wireless access by establishing uplink (dashed line) and/or downlink (dotted line) connections with UE 104 and UE 105, such as a base station, a NodeB, an enhanced nodeB (eNB), an access point, a picocell, a femtocell, and other wirelessly enabled devices. UE 104 and UE 105 may be any component capable of establishing a wireless connection with communications controller 102, such as cell phones, smart phones, tablets, sensors, etc. Backhaul network 108 may be any component or collection of components that allow data to be exchanged between communications controller 102 and a remote end. In some embodiments, the network 100 may include various other wireless devices, such as relays, etc.

FIG. 2 illustrates system 110, a wireless system for local traffic splitting. Communications controller 114 receives a traffic flow from source 112 destined for UE 118, with an input flow at rate r_{A}. This may be a sub-flow of a larger traffic flow with rate r where the traffic flows with rate r−r_{A} go to other communications controllers destined for UE 118. When communications controller 114 cannot meet the target quality of service (QoS) for a flow to UE 118, for example a target rate or delay for the flow, communications controller 114 may relay some of the traffic to one or more neighboring communications controller(s), such as communications controller 116. Communications controller 114 may learn of candidate communications controller from a report from UE 118, or from a third party, such as a controller. Alternatively, communications controller 114 determines candidate communications controllers by itself using criteria such as the UE's location, a topology map, or another factor. The QoS of a flow from communications controller 116 to UE 118 may be considered, as well as the link between communications controller 114 and communications controller 116. Communications controller 114 splits the input flow with rate r_{A} into a sub-flow with rate r′_{A}, which it forwards directly to UE 118, and a sub-flow with rate r′_{B}, which it forwards to communications controller 116. Then, communications controller 116 transmits flow at rate r′_{B} to UE 118.

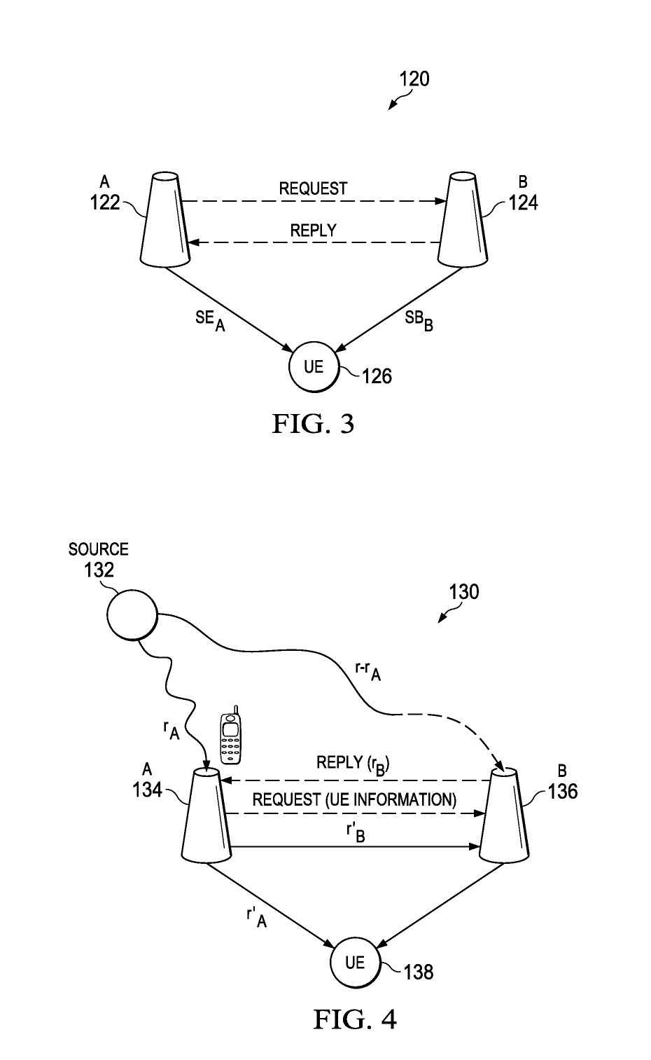

FIG. 3 illustrates signaling in system 120. Communications controller 122 transmits a request to communications controller 124 with information on UE 126, such as the identity of UE 126. Communications controller 124 transmits a reply to communications controller 122 containing the QoS which communications controller 124 can provide for a flow to UE 126 based on loading of communications controller 124 and the channel between communications controller 124 and UE 126. For example, no service is available when communications controller 124 is already over-provisioned. In another example, communications controller 124 periodically updates communications controller 122 with its potential support for UE 126.

FIG. 4 illustrates system 130, a wireless network with signaling for local splitting. The target rate r_{A} is the target rate to satisfy a QoS for a flow to UE 138 from node 134 from source node 132. The target rate is produced during traffic engineering. The rate that communications controller 124 can support to UE 138 is r_{B}, which is equal to:

r_{B}=SE_{B}×R_{B},

where SE_{B} is the spectral efficiency of the wireless channel from communications controller 136 to UE 138 and R_{B} is the available resource at communications controller 136. Communications controller 134 transmits a request to communications controller 136 with the identity of the destination, and communications controller 136 responds with a rate it can support, for example r_{B}. Communications controller 134 determines the local traffic splitting. The local traffic splitting is chosen so that the data rate r′_{B} from communications controller 134 to communications controller 136 is given by:

r_{B}′≦min(rₘₐₓ,r_{B},C_{AB}),

where C_{AB} is the available capacity on the link from communications controller 134 to communications controller 136 and rₘₐₓ is an optional parameter indicating the maximum data rate to be off-loaded. Also, the condition:

$${r}_{A}^{′} + {\sum }_{B}^{ } {r}_{B}^{′} \leq {r}_{A}$$

is met, where B are the communications controllers used to route traffic to UE 138.

Also, local traffic splitting may be used in the backhaul network. The nodes in the flow path monitor their own buffer status. When congestion occurs, one or more new path(s) to the destination are added to share the flow traffic load with the original path. In one example, new paths are added from congested nodes en route to the destination. Alternatively, new paths are added from the source. The new paths may be, for example, pre-configured and pre-associated with a splitting ratio for handling congestion by routes which may be added from any en route node prior to the congestion nodes, including the congested nodes, upon receiving a signal from congested nodes.

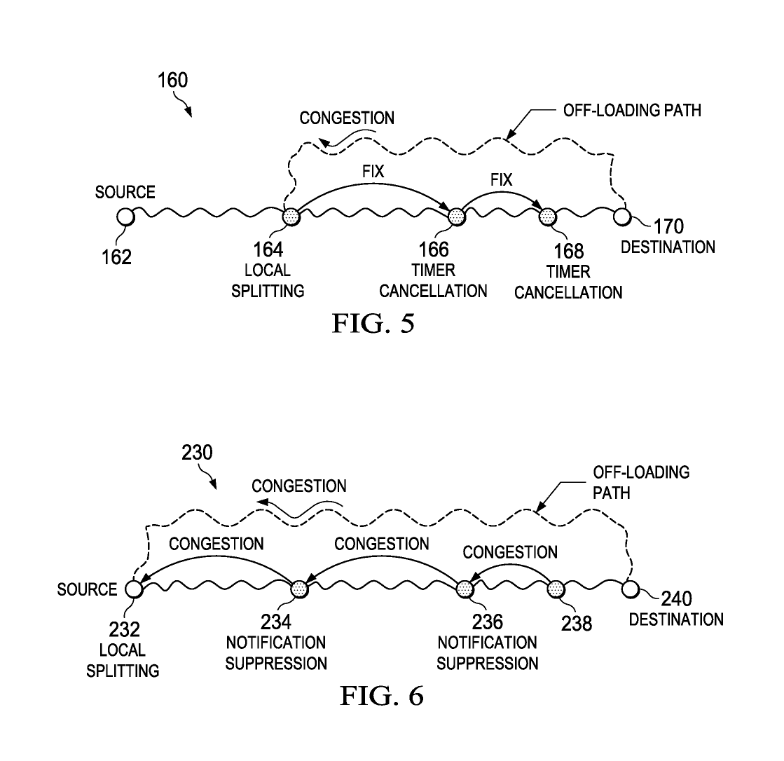

FIG. 5 illustrates system 160, a backhaul network where local splitting is performed at congested nodes along the route. The data path goes from source node 162, to node 164, to node 166, to node 168, to destination 170. In this example, nodes 164, 166, and 168 are congested. Local splitting may occur at one or more of these nodes. In one example, at the onset of the congestion, a node starts a timer with a timeout interval proportional to the node's hop distance from the source. When the timer expires, the node performs local splitting to find another route to destination 170. The timer is used to prevent multiple nodes from performing traffic splitting at the same time for one instance of congestion. Meanwhile, the congested node sends a FIX message along the downstream path. When a congested node receives a FIX message, it cancels its timer, if started, and forwards the message along the downstream path.

FIG. 6 illustrates system 230, a backhaul network where local splitting is performed by the source node. A data path goes from source node 232, to node 234, to node 236, to node 238, to destination 240. A congested node transmits a CONGESTION message along the upward path towards source node 162 when it detects sufficiently severe congestion. When the congested node has previously forwarded a congestion message to source node 232 within a certain period of time, it does not send another message. When source node 232 receives a congestion message, it performs local splitting. Alternate routes may be pre-computed or dynamically determined.

The initiator node, or the node which initiates the traffic splitting, performs local splitting by adding additional paths, called offloading paths, from itself to the destination. There may be an upper bound for the number of offloading paths. In one example, the splitting is performed evenly, where each offloaded sub-flow has the same rate. In another example, the splitting is more complex, for example based on resource reservation protocol (RSVP). Off-loading paths may be pre-configured or dynamically computed. Dynamic path computation respects the node loading. A load aware routing algorithm, such as using a wireless mesh network, may be used. When off-loading paths are congested, the initiator node is informed of the congestion and adjusts the flow splitting.

Congestion may remain after the initiator performs local splitting. When congestion continues, the initiator node may trigger incremental load splitting. Incremental local splitting occurs at the initiator node or at other nodes along the original routing path. Alternatively, the initiator node cancels local splitting to avoid complicated operations. Protocol decisions on timer cancellation, message suppression, and local splitting cancellation may expire after a period of time to facilitate incremental local fixing and adaptation to network dynamics.

Pre-computing of local splitting ratios may be done jointly with traffic engineering using soft rate allocations. Two candidate path sets Rᵢ and R′ᵢ are pre-determined for each flow i. There are two rate allocation decisions per flow. A hard rate allocation satisfies the mean rate requirement using the primary candidate path set 6 and a soft rate allocation handles rate variation using the secondary candidate path set. Flow satisfaction constraints are applied using hard rate allocation. The utility function of each flow has two parts, the hard rate utility and soft rate utility. Traffic splitting may follow the hard rate allocation decision. When congestion occurs, the additional traffic is handled by local splitting following soft rate allocation decisions. For example:

$$max {\sum }_{i ∈ F}^{ } ( mU ( {x}_{i} ) + {p}_{i} {U}^{′} ( {y}_{i} ) ) ,$$

such that:

$${\sum }_{k ∈ {R}_{i}}^{ } {x}_{ik} = {x}_{i} , \\ ∀ i ∈ F , \\ {x}_{i} \leq {d}_{i} , \\ and$$

$$∀ i ∈ F ,$$

where m is a very large constant so the flow's soft rate allocation is less than its demand satisfaction in utility, pᵢ is the flow priority, reflecting the rate of variance, xᵢₖ is the rate allocation of flow i on its path k for average demand satisfaction, xᵢ is the rate allocation of flow rate i for satisfying the average rate demand, F is the flow set, and dᵢ is the average rate demand of flow rate i. Also:

$${\sum }_{i ∈ F}^{ } ( {\sum }_{k ∈ {R}_{i}}^{ } {δ}_{e}^{i , k} {x}_{ik} + {\sum }_{k ∈ {R}_{i}^{′}}^{ } {δ}_{e}^{i , k} {y}_{ik} ) \leq {c}_{e} , ∀ e ∈ G ,$$

where δₑ^{i,k} is an indicator of link e belonging in path k of flow i, cₑ is the capacity of link e, and yᵢₖ is the soft rate allocation of flow i on its path k for handling rate variation. Also, where:

$${\sum }_{k ∈ {R}_{i}^{′}}^{ } {y}_{ik} = {y}_{i} , ∀ i ∈ F ,$$

where yᵢ is the rate allocation of flow rate i for handling rate variance. Then:

xᵢₖ≧0,∀kεRᵢ,∀iεF,

and

yᵢₖ≧0,∀kεR′ᵢ,∀iεF,

where Rᵢ is a primary candidate path set of flow i and R′ᵢ a secondary candidate path set.

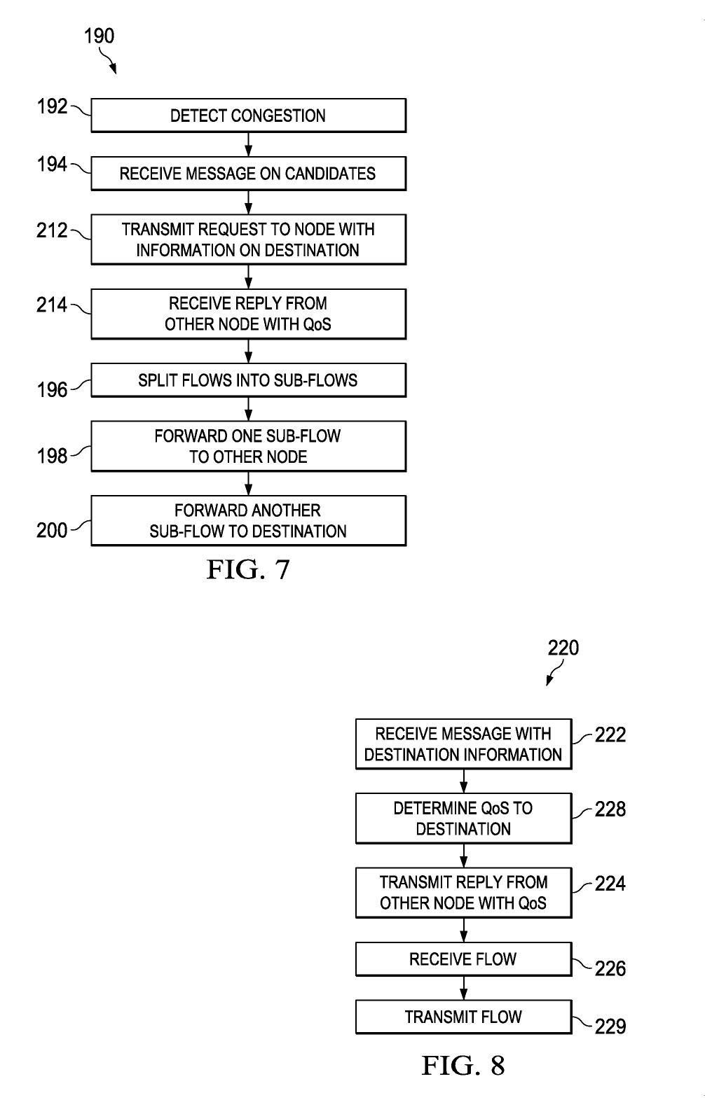

FIG. 7 illustrates flowchart 190 for a method of local traffic splitting performed by a node, such as a communications controller. Initially, in step 192, the node detects congestion. In this example, the node decides to seek help upon noticing congestion. In one example, prior to seeking help, the node waits for a period of time to determine whether the congestion is sufficiently lasting to warrant seeking help.

After deciding to seek help, the node receives a message on candidates in step 194. For example, the node receives a message from a UE on the candidates. In another example, the node receives a message from a controller. Alternatively, the node does not receive a message, and already has knowledge of candidates, for example by being periodically updated, based on the location of the destination, or a topology map. In another example, the node periodically receives updates from UEs.

Then, in step 212, the node transmits a message to a helper node, such as another communications controller. The message contains information on the destination. For example, the message contains the identity of the destination UE.

In response, the node receives a reply from the helper node in step 214. The reply message may contain information on the QoS the helper node can provide for a flow to the destination. When the other node does not have additional capacity, it replies that it cannot accept extra traffic.

In step 196, the node splits the flow into sub-flows. The flow rate to the helper node may be set to a rate less than or equal to the minimum of the maximum flow rate to be off-loaded, the flow rate the helper node can provide to the destination node, and the capacity on the link from the node to the helper node. One sub-flow is sent to the destination along the original path, for example directly to the destination, while another sub-flow is to the helper node. The flow may be split into more than two sub-flows, where multiple helper nodes receive their own sub-flows, and one sub-flow going directly to the destination node. The sum of the sub-flows is less than or equal to the data flowing into this node.

After splitting the flow into a set of sub-flows, the node forwards one sub-flow to the helper node in step 198.

In step 200, the node forwards one of the sub-flows to the destination node. For example, the sub-flow is sent along the original path.

FIG. 8 illustrates flowchart 220 for a method of local traffic splitting performed by a helper node, such as a communications controller. Initially, in step 222, the helper node receives a message from another node, such as another communications controller. The message may contain information on the destination, such as the identity of the destination UE.

Then, in step 228, the helper node determines the QoS it can provide for a flow to the destination node. This may be done based on the current load of the helper node, the channel to the destination from the helper node, and the channel or link from the requesting node to the helper node. When the helper node is already at capacity or over-provisioned, it cannot provide any QoS.

Next, in step 224, the helper node transmits a reply message to the node requesting assistance. The reply message contains information on the QoS the helper node can provide for a flow to the destination.

Then, in step 226, the node receives a traffic flow from the requesting node destined for the destination.

Finally, in step 229, the node transmits the flow to the destination.

It should be understood that congestion, when it occurs can be noticed by a number of nodes along the path of a data flow. If multiple nodes act to address the path of a data flow independently of each other, the independent solutions may not provide any performance improvement over a single node acting to address the problem as described above. Furthermore, having multiple noes acting independently may result in a suboptimal result as there will be increased overhead at a minimum.

In an embodiment described below, nodes along the flow path can make use of control signaling to notify each other that a flow splitting has occurred in in an attempt to address congestion. For the purposes of the following discussion—a control signaling message involving nodes of a flow split will be referred to as a fix message. The naming of this message should not be viewed as limiting.

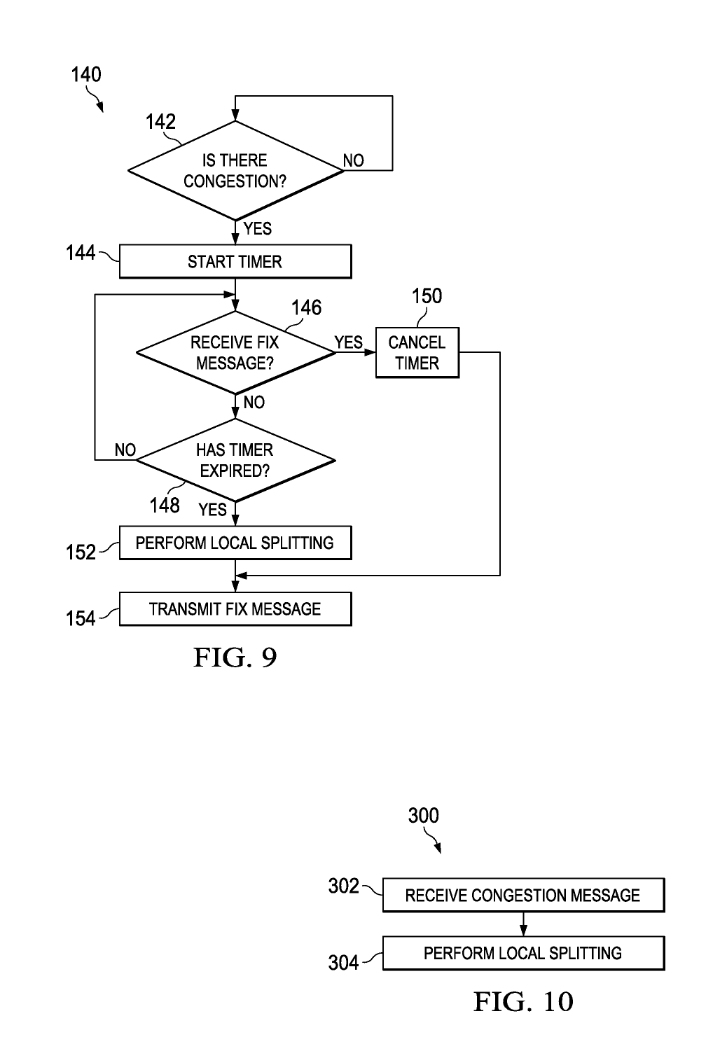

Because a node knows that it will be told of flow splitting at other nodes, upon detecting congestion it can perform a flow splitting if a time interval elapses before the node receives a fix message from another node. To ensure that other nodes receive a fix message, when a node receives a flow splitting fix message, it can ignore it during a time interval, bypass the flow splitting, and send the fix message along the flow path (continuing the direction of the message, e.g. to the node in the flow path that did not send the fix message). One such example embodiment is provided by FIG. 9.

FIG. 9 illustrates flowchart 140 for a method of local traffic splitting performed by a node in a backhaul network. Initially, in step 142, the node determines whether there is congestion. When there is no congestion, the node continues to monitor the link for congestion. When the node detects congestion, it proceeds to step 144.

In step 144, the node starts a timer. The node only performs local splitting when the congestion has occurred for a period of time, to avoid multiple instances of traffic splitting for a single instance of congestion, and so only lasting congestion leads to local traffic splitting.

Then, in step 146, the node checks whether it has received a fix message. When the node has not received a fix message, the node proceeds to step 148. When the node has received a fix message, it proceeds to step 150.

In step 150, the node cancels the timer, because the congestion is already being dealt with by another node. Then, it proceeds to step 154.

In step 154, the node transmits a fix message to other nodes in the data stream. The fix message indicates that the congestion has been fixed to other nodes, so the other nodes do not also perform local splitting. The fix message may be transmitted just upstream, just downstream, or both upstream and downstream. As one skilled in the art will appreciate, the terms upstream and downstream are conventional terms of the art referring to the direction of the source of a flow, and the destination of a flow respectively.

In step 148, the node determines whether the timer has expired. When the timer has not expired, the node returns to step 146 to monitor fixed messages. When the timer has expired without receipt of the FIX message, the node proceeds to step 152 to perform local splitting.

In step 152, the node performs local splitting. The node finds additional paths with extra capacity to the destination. Then, the node forwards a portion of the flow to the additional path(s). The node performs local splitting by adding off-loading path(s) from itself to the destination. There may be an upper limit on the number of off-loading paths. In one example, the splitting is performed evenly. Alternatively, the splitting is performed unevenly, for example using RSVP.

The offloading may be dynamically computed or pre-configured. When the offloading is performed dynamically, it respects the node load. A distributed load-aware routing algorithm may be used.

Pre-computing of local splitting ratios may be done jointly with traffic engineering using soft rate allocations. Two candidate path sets Rᵢ and R′ᵢ are pre-determined for each flow i. There are two rate allocation decisions per flow. A hard rate allocation satisfies the mean rate requirement using the primary candidate path set and a soft rate allocation handles rate variation using the secondary candidate path set. Flow satisfaction constraints are applied using the hard rate allocation. The utility function of each flow has two parts, the hard rate utility and soft rate utility. Traffic splitting may follow the hard rate allocation decision. When congestion occurs, the additional traffic is handled by local splitting following soft rate allocation decisions. For example:

$$max {\sum }_{i ∈ F}^{ } ( mU ( {x}_{i} ) + {p}_{i} {U}^{′} ( {y}_{i} ) ) ,$$

such that:

$${\sum }_{k ∈ {R}_{i}}^{ } {x}_{ik} = {x}_{i} , \\ ∀ i ∈ F , \\ {x}_{i} \leq {d}_{i} , \\ and$$

$$∀ i ∈ F ,$$

where m is a very large constant so the flow's soft rate allocation is less than its demand satisfaction in utility, pᵢ is the flow priority, reflecting the rate of variance, xᵢₖ is the rate allocation of flow i on its path k for average demand satisfaction, xᵢ is the rate allocation of flow rate i for satisfying the average rate demand, F is the flow set, U(xᵢ) is the hard rate utility, U′(yᵢ) is the soft rate utility, and dᵢ is the average rate demand of flow rate i. Also:

$${\sum }_{i ∈ F}^{ } ( {\sum }_{k ∈ {R}_{i}}^{ } {δ}_{e}^{i , k} {x}_{ik} + {\sum }_{k ∈ {R}_{i}^{′}}^{ } {δ}_{e}^{i , k} {y}_{ik} ) \leq {c}_{e} , ∀ e ∈ G ,$$

where δₑ^{i,k} is an indicator of link e belonging in path k of flow i, cₑ is the capacity of link e, and yᵢₖ is the soft rate allocation of flow i on its path k for handling rate variation. Also:

$${\sum }_{k ∈ {R}_{i}^{′}}^{ } {y}_{ik} = {y}_{i} , ∀ i ∈ F ,$$

where yᵢ is the rate allocation of flow rate i for handling rate variance. Then:

xᵢₖ≧0,∀kεRᵢ,∀iεF,

and

yᵢₖ≧0,∀kεR′ᵢ,∀iεF,

where Rᵢ is a primary candidate path set of flow i and R′ᵢ a secondary candidate path set.

After performing local splitting, the node transmits a fix message in step 154.

FIG. 10 illustrates flowchart 300 for a method of performing local splitting by a source node in a backhaul network. Initially, in step 302, the source node receives a congestion message from another node in the flow.

Next, in step 304, the source node performs local splitting. The source node directs a sub-stream to the destination along another path. The node performs local splitting by adding off-loading path(s) from itself to the destination. The offloading may be dynamically computed or pre-configured. When the offloading is performed dynamically, it respects the node load. In one example, a distributed load-aware routing algorithm is used.

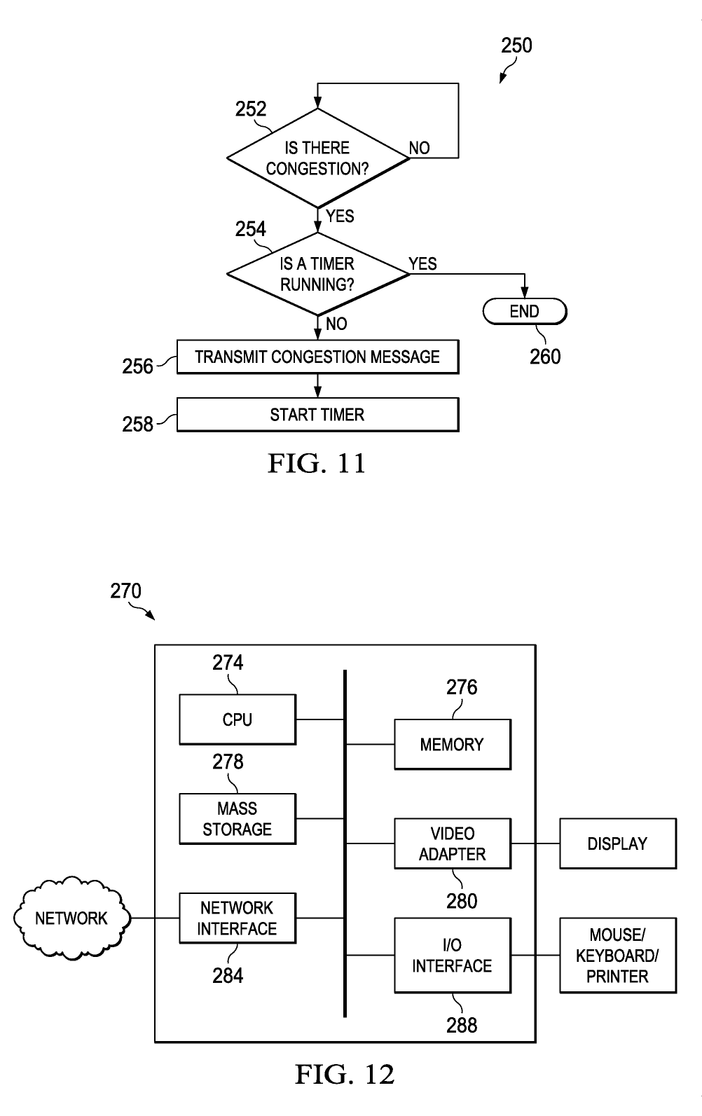

FIG. 11 illustrates flowchart 250 for a method of detecting traffic congestion in a node of a backhaul network. This method may be used in conjunction with a method of performing traffic splitting, for example the method illustrated by flowchart 300 in FIG. 10. When the node does not detect congestion, it continues monitoring for congestion in step 252. When the node detects congestion, it proceeds to step 254.

In step 254, the node determines whether a timer is already running. When the timer is already running, the node proceeds to step 260, and ends this procedure. When the timer is not already running, the node proceeds to step 256.

In step 256, the node transmits a congestion message to the source node.

Finally, in step 258, the node starts the timer.

Pre-computing of local splitting ratios may be done jointly with traffic engineering using soft rate allocations. Two candidate path sets Rᵢ and R′ᵢ are pre-determined for each flow i. There are two rate allocation decisions per flow. A hard rate allocation satisfies the mean rate requirement using the primary candidate path set and a soft rate allocation handles rate variation using the secondary candidate path set. Flow satisfaction constraints are applied using hard rate allocation. The utility function of each flow has two parts, the hard rate utility and soft rate utility. Traffic splitting may follow the hard rate allocation decision. When congestion occurs, the additional traffic is handled by local splitting following soft rate allocation decisions. For example:

$$max {\sum }_{i ∈ F}^{ } ( mU ( {x}_{i} ) + {p}_{i} {U}^{′} ( {y}_{i} ) ) ,$$

such that:

$${\sum }_{k ∈ {R}_{i}}^{ } {x}_{ik} = {x}_{i} , \\ ∀ i ∈ F , \\ {x}_{i} \leq {d}_{i} , \\ and$$

$$∀ i ∈ F ,$$

where m is a very large constant so the flow's soft rate allocation is less than its demand satisfaction in utility, pᵢ is the flow priority, reflecting the rate of variance, xᵢₖ is the rate allocation of flow i on its path k for average demand satisfaction, xᵢ is the rate allocation of flow rate i for satisfying the average rate demand, F is the flow set, and dᵢ is the average rate demand of flow rate i. Also:

$${\sum }_{i ∈ F}^{ } ( {\sum }_{k ∈ {R}_{i}}^{ } {δ}_{e}^{i , k} {x}_{ik} + {\sum }_{k ∈ {R}_{i}^{′}}^{ } {δ}_{e}^{i , k} {y}_{ik} ) \leq {c}_{e} , ∀ e ∈ G ,$$

where δₑ^{i,k} is an indicator of link e belonging in path k of flow i, cₑ is the capacity of link e, and yᵢₖ is the soft rate allocation of flow i on its path k for handling rate variation. Also:

$${\sum }_{k ∈ {R}_{i}^{′}}^{ } {y}_{ik} = {y}_{i} , ∀ i ∈ F ,$$

where yᵢ is the rate allocation of flow rate i for handling rate variance. Then:

xᵢₖ≧0,∀kεRᵢ,∀iεF,

and

yᵢₖ≧0,∀kεR′ᵢ,∀iεF,

where Rᵢ is a primary candidate path set of flow i and R′ᵢ a secondary candidate path set.

FIG. 12 illustrates a block diagram of processing system 270 that may be used for implementing the devices and methods disclosed herein. Specific devices may utilize all of the components shown, or only a subset of the components, and levels of integration may vary from device to device. Furthermore, a device may contain multiple instances of a component, such as multiple processing units, processors, memories, transmitters, receivers, etc. The processing system may comprise a processing unit equipped with one or more input devices, such as a microphone, mouse, touchscreen, keypad, keyboard, and the like. Also, processing system 270 may be equipped with one or more output devices, such as a speaker, a printer, a display, and the like. The processing unit may include central processing unit (CPU) 274, memory 276, mass storage device 278, video adapter 280, and I/O interface 288 connected to a bus.

The bus may be one or more of any type of several bus architectures including a memory bus or memory controller, a peripheral bus, video bus, or the like. CPU 274 may comprise any type of electronic data processor. Memory 276 may comprise any type of non-transitory system memory such as static random access memory (SRAM), dynamic random access memory (DRAM), synchronous DRAM (SDRAM), read-only memory (ROM), a combination thereof, or the like. In an embodiment, the memory may include ROM for use at boot-up, and DRAM for program and data storage for use while executing programs.

Mass storage device 278 may comprise any type of non-transitory storage device configured to store data, programs, and other information and to make the data, programs, and other information accessible via the bus. Mass storage device 278 may comprise, for example, one or more of a solid state drive, hard disk drive, a magnetic disk drive, an optical disk drive, or the like.

Video adaptor 280 and I/O interface 288 provide interfaces to couple external input and output devices to the processing unit. As illustrated, examples of input and output devices include the display coupled to the video adapter and the mouse/keyboard/printer coupled to the I/O interface. Other devices may be coupled to the processing unit, and additional or fewer interface cards may be utilized. For example, a serial interface card (not pictured) may be used to provide a serial interface for a printer.

The processing unit also includes one or more network interface 284, which may comprise wired links, such as an Ethernet cable or the like, and/or wireless links to access nodes or different networks. Network interface 284 allows the processing unit to communicate with remote units via the networks. For example, the network interface may provide wireless communication via one or more transmitters/transmit antennas and one or more receivers/receive antennas. In an embodiment, the processing unit is coupled to a local-area network or a wide-area network for data processing and communications with remote devices, such as other processing units, the Internet, remote storage facilities, or the like.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method for traffic splitting, the method comprising:
detecting congestion in a traffic flow;
splitting the traffic flow into a first sub-flow and a second sub-flow after detecting congestion in the traffic flow;
transmitting, by a first node to a destination node, the first sub-flow along a first path; and
transmitting, by the first node to a second node, the second sub-flow along a second path, wherein the second sub-flow is destined for the destination node.

2. The method of claim 1, wherein the second path is different from the first path.

3. The method of claim 1, further comprising:
transmitting, by the first node to the second node, an identity of the destination node; and
receiving, by the first node from the second node, a quality of service (QoS) the second node can provide the second sub-flow to the destination node.

4. The method of claim 1, wherein detecting congestion in the traffic flow comprises:
monitoring a buffer for the traffic flow; and
determining that there is congestion when the buffer is above a threshold.

5. The method of claim 1, further comprising selecting the second node before splitting the traffic flow.

6. The method of claim 5, wherein selecting the second node comprises receiving, by the first node from the destination node, an identity of the second node.

7. The method of claim 5, wherein selecting the second node comprises receiving, by the first node from a controller, an identity of the second node.

8. The method of claim 5, wherein selecting the second node comprises detecting the second node in accordance with a topology map.

9. The method of claim 5, wherein selecting the second node comprises receiving, by the first node from the second node, a message.

10. The method of claim 1, wherein a first rate of the second sub-flow is less than or equal to a minimum of a maximum flow rate for offloading, a second rate the second node can provide to the destination node, or a capacity between the first node and the second node.

11. The method of claim 1, wherein the first node is a first communications controller, the second node is a second communications controller, and the destination node is a user equipment (UE).

12. The method of claim 1, further comprising transmitting, by the first node to a third node, a fix message after splitting the traffic flow.

13. The method of claim 1, wherein splitting the traffic flow occurs after a time interval has elapsed.

14. The method of claim 1, further comprising:
starting a timer; and
cancelling the timer when receiving a fix message while the timer is running, wherein splitting the traffic flow occurs when the timer has expired and no fix message has been received while the timer is running.

15. The method of claim 1, wherein detecting congestion comprises receiving, by the first node from a third node, a congestion message.

16. The method of claim 1, wherein splitting the traffic flow further comprises splitting the traffic flow into the first sub-flow, the second sub-flow, and a third sub-flow.

17. The method of claim 1, further comprising determining the first sub-flow and the second sub-flow after detecting the congestion.

18. The method of claim 17, further comprising receiving, by the first node from a traffic engineering controller, a pre-computed first sub-flow and a pre-computed second sub-flow.

19. The method of claim 1, further comprising:
pre-computing the first sub-flow; and
pre-computing a path of the second sub-flow.

20. The method of claim 19, further comprising pre-computing a rate limit for the second sub-flow over the path.

21. A method for traffic splitting, the method comprising:
receiving, by a first communications controller from a second communications controller, an identity of a user equipment (UE);
determining a maximum rate the first communications controller can provide to the UE;
transmitting, by the first communications controller to the second communications controller, the maximum rate; and
receiving, by the first communications controller, a traffic flow having a first rate, wherein the rate is less than or equal to the maximum rate.

22. The method of claim 21, further comprising transmitting, by the first communications controller to the UE, the traffic flow.

23. A communications node comprising:
a processor; and
a non-transitory computer readable storage medium storing programming for execution by the processor, the programming including instructions to
detect congestion in a traffic flow,
split the traffic flow into a first sub-flow and a second sub-flow when there is congestion in the traffic flow,
transmit, to a destination node, the first sub-flow, and
transmit, to another communications node, the second sub-flow, wherein the second sub-flow is destined for the destination node.
